(19) United States
(12) Patent Application Publication
(10) Pub. No.: US 2026/0273400 A1
(43) Pub. Date: Sep. 17, 2026

(54) INFORMATION PROCESSING METHOD, AND ELECTRONIC DEVICE, AND STORAGE MEDIUM THEREOF

(71) Applicant: NETEASE (HANGZHOU) NETWORK CO., LTD., Hangzhou, Zhejiang (CN)

(72) Inventor: Xiaocheng YANG, Hangzhou, Zhejiang (CN)

(73) Assignee: NETEASE (HANGZHOU) NETWORK CO., LTD., Hangzhou, Zhejiang (CN)

(21) Appl. No.: 18/846,686

(22) PCT Filed: Oct. 19, 2022
(86) PCT No.: PCT/CN2022/126175

§ 371 Date: Sep. 13, 2024

(30) Foreign Application Priority Data
Mar. 24, 2022 (CN) 202210295544.X

(51) Int. Cl. G06F 3/04847; A63F 13/803

(52) U.S. Cl. CPC G06F 3/04847; A63F 13/803

(57) ABSTRACT

An information processing method, an electronic device, and a storage medium are provided. The method includes: in response to a slide operation sliding into a graphical user interface from an edge of the graphical user interface, displaying in the graphical user interface a target rearview mirror image of a target rearview mirror corresponding to the slide operation.

### CROSS-REFERENCE TO RELATED APPLICATIONS

This disclosure claims priority to Chinese patent application number 202210295544.X filed on Mar. 24, 2022, entitled “Information processing method and apparatus, electronic device, storage medium”, the entire contents of which are incorporated herein by reference.

### TECHNICAL FIELD

This disclosure relates to the field of computer technology, and in particular to an information processing method and apparatus, electronic device, and storage medium.

### BACKGROUND

With the development of network technology, more and more games are applied to mobile terminals. Generally, games can be divided into: racing type games, shooting type games, strategy type games, action type games, role-playing type games, music type games, etc.

The most popular racing type games are various types of car racing games. In car racing games, game players not only need to observe the road condition and the race situation in front of the field of view, but also need to observe the race situation behind the field of view, to make different response strategies.

In the relevant racing type games, during the game running, a fixed button is displayed on the game interface. When the player needs to view the rearview mirror image, he needs to click the button to display the rearview mirror image in full screen on the game interface. In this process, when the player wants to view the rearview mirror image, he must accurately click the button for displaying the rearview mirror image, which is prone to misoperation or failure to trigger, and has a low fault tolerance rate. Besides, in the relevant technology, it will interrupt the content currently displayed on the game interface when displaying the rearview mirror image, which affects judgment of the player on the road condition and race situation in front of the field of view. When it is necessary to restore the display of the road condition in front of the field of view, the player needs to click the relevant button again (at this time, it is a button to cancel the display of the rearview mirror image), and the operation is relatively cumbersome.

It should be noted that the information disclosed in the above background technology section is only used to enhance the understanding of the background of this disclosure, and therefore may include information that does not constitute prior art known to ordinary technicians in the field.

### SUMMARY

In view of the above problems, the present disclosure is proposed to provide an information processing method and apparatus, electronic device, and storage medium, to overcome the above problems or at least partially solve the above problems, including:
an information processing method, wherein an application is executed on a processor of a terminal device and a graphical user interface is rendered on a touch display screen of the terminal device, the graphical user interface at least presents a picture in front of field of view of a target virtual object, and the method includes:
displaying a target rearview mirror image of a target rearview mirror corresponding to a swiping operation in the graphical user interface, in response to the swiping operation swiping from an edge of the graphical user interface into the graphical user interface.

Optionally, displaying a target rearview mirror image of a target rearview mirror corresponding to a swiping operation in the graphical user interface in response to the swiping operation swiping from an edge of the graphical user interface into the graphical user interface, includes:
determining the target rearview mirror corresponding to the swiping operation according to a target edge when the swiping operation swipes into the graphical user interface, in response to the swiping operation swiping from the edge of the graphical user interface into the graphical user interface.

Optionally, displaying a target rearview mirror image of a target rearview mirror corresponding to a swiping operation in the graphical user interface in response to the swiping operation swiping from an edge of the graphical user interface into the graphical user interface, includes:
determining the target rearview mirror corresponding to the swiping operation according to a target swiping direction of the swiping operation, in response to the swiping operation swiping from the edge of the graphical user interface into the graphical user interface.

Optionally, displaying a target rearview mirror image of a target rearview mirror corresponding to a swiping operation in the graphical user interface in response to the swiping operation swiping from an edge of the graphical user interface into the graphical user interface, includes:
in response to the swiping operation swiping from the edge of the graphical user interface into the graphical user interface, determining the target rearview mirror corresponding to the swiping operation according to a target edge, when a target swiping direction of the swiping operation matches a preset swiping direction corresponding to the target edge when the swiping operation swipes into the graphical user interface.

Optionally, displaying a target rearview mirror image of a target rearview mirror corresponding to a swiping operation in the graphical user interface includes:
determining a target display area corresponding to the target rearview mirror, and displaying the target rearview mirror image in the target display area.

Optionally, the method further includes:
ending display of the target rearview mirror image, in response to that a continuous display duration of the target rearview mirror image in the graphical user interface reaches a preset duration.

Optionally, the method further includes:
when the target rearview mirror is a first rearview mirror and in a process of displaying a first rearview mirror image of the first rearview mirror, in response to the swiping operation corresponding to a second rearview mirror, displaying a second rearview mirror image of the second rearview mirror in the graphical user interface, and ending display of the first rearview mirror image simultaneously.

An information processing apparatus, wherein an application is executed on a processor of a terminal device and a graphical user interface is rendered on a touch display screen of the terminal device, the graphical user interface at least presents a picture in front of field of view of a target virtual object, and the apparatus includes:
a target rearview mirror image display module, configured to display a target rearview mirror image of a target rearview mirror corresponding to a swiping operation in the graphical user interface, in response to the swiping operation swiping from an edge of the graphical user interface into the graphical user interface.

Optionally, the target rearview mirror image display module includes:
a target rearview mirror first determination module, configured to determine the target rearview mirror corresponding to the swiping operation according to a target edge when the swiping operation swipes into the graphical user interface, in response to the swiping operation swiping from the edge of the graphical user interface into the graphical user interface.

Optionally, the target rearview mirror image display module includes:
a target rearview mirror second determination module, configured to determine the target rearview mirror corresponding to the swiping operation according to a target swiping direction of the swiping operation, in response to the swiping operation swiping from the edge of the graphical user interface into the graphical user interface.

Optionally, the target rearview mirror image display module includes:
a target rearview mirror third determination module, configured to: in response to the swiping operation swiping from the edge of the graphical user interface into the graphical user interface, when a target swiping direction of the swiping operation matches a preset swiping direction corresponding to the target edge when the swiping operation swipes into the graphical user interface, determine the target rearview mirror corresponding to the swiping operation according to a target edge.

Optionally, the target rearview mirror image display module is configured to determine a target display area corresponding to the target rearview mirror, and display the target rearview mirror image in the target display area.

Optionally, the apparatus further includes:
an ending display module, configured to end display of the target rearview mirror image, in response to that a continuous display duration of the target rearview mirror image in the graphical user interface reaches a preset duration.

Optionally, the apparatus further includes:
a second display module, configured to, when the target rearview mirror is a first rearview mirror and in a process of displaying a first rearview mirror image of the first rearview mirror, in response to the swiping operation corresponding to a second rearview mirror, display a second rearview mirror image of the second rearview mirror in the graphical user interface, and end display of the first rearview mirror image simultaneously.

An electronic device, including a processor, a memory, and a computer program stored in the memory and capable of running on the processor, wherein the computer program implements steps of the information processing method described above when executed by the processor.

A computer-readable storage medium, having a computer program stored thereon, wherein the computer program implements steps of the information processing method described above when executed by a processor.

### BRIEF DESCRIPTION OF THE DRAWINGS

In order to more clearly illustrate the technical solution of the present disclosure, the following will briefly introduce the drawings required in the description of the present disclosure. The drawings in the following description are only some embodiments of the present disclosure. For ordinary technicians in this field, other drawings can be obtained based on these drawings without creative labor.

FIG. 1 is a step flowchart of an information processing method of an embodiment of the present disclosure;

FIG. 2 is a schematic diagram of a swiping operation in an information processing method of an embodiment of the present disclosure;

FIG. 3 is a schematic diagram of a swiping direction in an information processing method of an embodiment of the present disclosure;

FIG. 4 is a schematic diagram of displaying a left rearview mirror image in an information processing method of an embodiment of the present disclosure;

FIG. 5 is a schematic diagram of displaying a right rearview mirror image in an information processing method of an embodiment of the present disclosure;

FIG. 6 is a schematic diagram of the relationship between the rearview mirror display area and the graphical user interface in an information processing method of an embodiment of the present disclosure; and

FIG. 7 is a structural block diagram of an information processing apparatus of an embodiment of the present disclosure.

### DETAILED DESCRIPTION

In order to make the above-mentioned purposes, features and advantages of the present disclosure more obvious and easy to understand, the present disclosure is further described in detail below in conjunction with the accompanying drawings and specific implementations. The described embodiments are part of the embodiments of the present disclosure, not all of the embodiments. Based on the embodiments in the present disclosure, all other embodiments obtained by ordinary technicians in the field without creative work are within the scope of protection of the present disclosure.

In the relevant racing type games, during the game running, a fixed button is displayed on the game interface. When the player needs to view the rearview mirror image, he needs to click the button to display the rearview mirror image in full screen on the game interface. In this process, when the player wants to view the rearview mirror image, he must accurately trigger the button for displaying the rearview mirror image, which is prone to misoperation or failure to trigger, and has a low fault tolerance rate. Besides, in the relevant technology, it will interrupt the content currently displayed on the game interface when displaying the rearview mirror image, which affects judgment of the player on the road condition and race situation in front of the field of view. When it is necessary to restore the display of the road condition in front of the field of view, the player needs to trigger a button to cancel the display of the rearview mirror image again, and the operation is relatively cumbersome.

In view of this, the embodiment of the present disclosure provides an information processing method, which determines the corresponding target rearview mirror through the swiping operation swiping from the edge of the graphical user interface into the graphical user interface, and displays the target rearview mirror image, which can reduce the use of interactive controls and facilitate user operation.

The information processing method provided by the embodiment of the present disclosure can be applied to electronic devices to facilitate users to perform game operations. The electronic device can be hardware or software. When the electronic device is hardware, it can be implemented as a cluster consisting of multiple servers or terminal devices, or a single server or a single terminal device. When the electronic device is software, it can be installed in the hardware devices listed above.

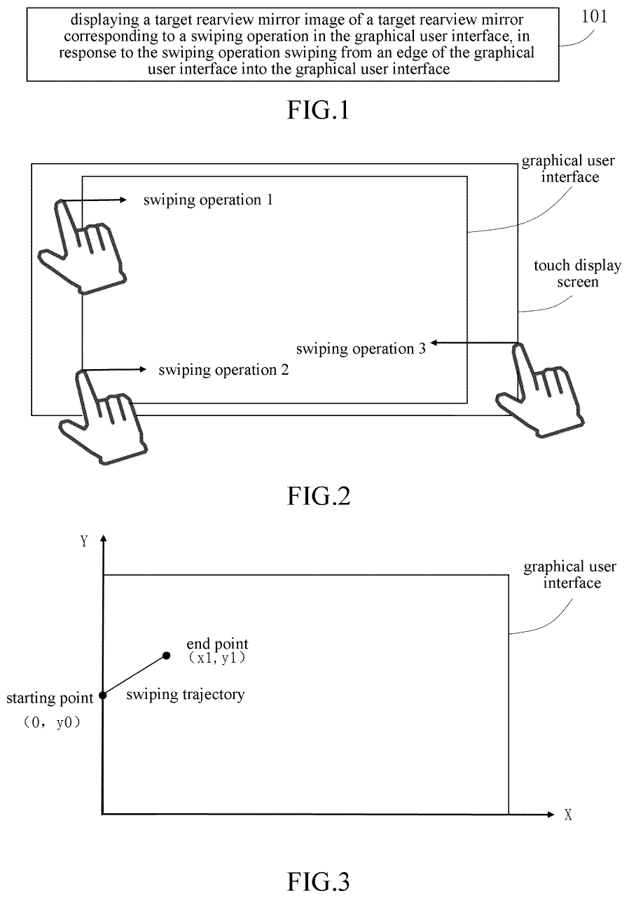

Referring to FIG. 1, a step flowchart of an information processing method provided by an embodiment of the present disclosure is shown. By executing an application on the processor of the terminal device and rendering a graphical user interface on the touch display screen of the terminal device, the graphical user interface at least presents the picture in front of the field of view of the target virtual object.

In the embodiment of the present disclosure, the application executed on the processor of the terminal device can be an application that needs to be downloaded and installed, or it can be a click-to-run application, and the embodiment of the present disclosure does not limit this. The terminal device can be an electronic device such as a smart phone, a tablet computer, a game console, an e-book reader, a multimedia playback device, a wearable device, etc.

In the embodiments of the present disclosure, the above-mentioned application can be any application that can provide a virtual environment for users to immerse and operate virtual objects to carry out activities in the virtual environment. Typically, the application is a game application, such as a multiplayer online racing game. In addition to game applications, other types of applications can also display virtual objects to users and provide corresponding functions to virtual objects. For example, virtual reality (VR) applications, augmented reality (AR) applications, three-dimensional map applications, military simulation applications, social applications, etc., which are not limited in the embodiments of the present disclosure. In addition, for different applications, the form of the virtual objects provided by them will also be different, and the corresponding functions will also be different, which can be pre-configured according to actual needs, which is not limited in the embodiments of the present disclosure. Optionally, a client of the above-mentioned application is run in the terminal device.

The above-mentioned virtual environment is a scene provided by the client of an application (such as a game application) when it runs on a terminal device. The virtual environment refers to a scene created for virtual objects to carry out activities (such as game competitions), such as a virtual track, a virtual house, a virtual island, a virtual map, and a virtual building, or the like. The virtual environment can be a simulation environment of the real world, a semi-simulation and semi-fictitious environment, or a purely fictitious environment. The virtual environment can be a two-dimensional virtual environment, a 2.5-dimensional virtual environment, or a three-dimensional virtual environment, which is not limited in the embodiments of the present disclosure.

The above-mentioned target virtual object can be a virtual object controlled by a user account in an application. In the embodiments of the present disclosure, the target virtual object can be a virtual vehicle, a virtual ship, a virtual character, etc. The rearview mirror is a tool for presenting external information such as the direct rear and side rear of the virtual object. Taking the target virtual object as a virtual vehicle as an example, the virtual vehicle can have an interior rearview mirror, to present the rear information of the virtual vehicle, and/or have left and right rearview mirrors, which are used to present the left and right rear information of the virtual vehicle respectively.

The display picture of the virtual environment refers to the picture corresponding to the virtual environment displayed to the user in the graphical user interface. The display picture of the virtual environment can be a picture obtained by the virtual camera from the virtual environment. In one embodiment, the virtual camera can obtain the display picture of the virtual environment from the third perspective of the target virtual object controlled by the user. Optionally, the virtual camera is set obliquely above the target virtual object, and the application observes the virtual environment with the target virtual object as the center through the virtual camera, and obtains the display picture of the virtual environment with the target virtual object as the center. For example, when the target virtual object is a virtual vehicle, the display picture of the virtual environment obtained from the third perspective of the target virtual object includes the entire body of the virtual vehicle and the picture in front of the field of view of the virtual vehicle. When the target virtual object is the driver in the virtual vehicle, the display picture of the virtual environment obtained from the third perspective of the target virtual object includes part of the picture of the virtual vehicle including the driver and the picture in front of the front windshield of the virtual vehicle. In another embodiment, the virtual camera obtains the display picture of the virtual environment from the first perspective of the target virtual object. Optionally, the virtual camera is set directly in front of the target virtual object, and the application observes the virtual environment from the perspective of the target virtual object through the virtual camera, and obtains the display picture of the virtual environment with the target virtual object as the first perspective. For example, when the target virtual object is a virtual vehicle, the display picture of the virtual environment obtained with the target virtual object as the first perspective includes the picture in front of the field of view of the virtual vehicle. When the target virtual object is the driver in the virtual vehicle, the display picture of the virtual environment obtained from the first perspective of the target virtual object includes part of the picture in front of the driver in the virtual vehicle and the picture in front of the field of view of the driver. In other possible implementations, the placement position of the virtual camera is adjustable in real time. For example, the placement position of the virtual camera can be adjusted by responding to operation of switching the placement position of the virtual camera by the user.

In the disclosed embodiment, the display picture of the above virtual environment is a display picture for displaying the virtual environment provided by a racing type game, including the picture in front of the field of view of the target virtual object. As in the above example, when the target virtual object is a virtual vehicle, the display picture of the virtual environment obtained from the third perspective of the target virtual object includes the entire body of the virtual vehicle and the picture in front of the field of view of the virtual vehicle. When the target virtual object is the driver in the virtual vehicle, the display picture of the virtual environment obtained from the third perspective of the target virtual object includes part of the picture of the virtual vehicle including the driver and the picture in front of the front windshield of the virtual vehicle. When the target virtual object is a virtual vehicle, the display picture of the virtual environment obtained with the target virtual object as the first perspective includes the picture in front of the field of view of the virtual vehicle. When the target virtual object is the driver in the virtual vehicle, the display picture of the virtual environment obtained from the first perspective of the target virtual object includes part of the picture in front of the driver in the virtual vehicle and the picture in front of the field of view of the driver. That is, in the embodiment of the present disclosure, the picture in front of the field of view of the target virtual object may refer to any one of the picture in front of the field of view of the virtual vehicle, the picture in front of the windshield, and the picture in front of field of view of the driver. Those skilled in the art can set the presentation manner and display picture of the virtual environment in front of the field of view of the target virtual object according to specific needs, and the present disclosure is not limited to this.

The method may include the following step:
step 101, displaying a target rearview mirror image of a target rearview mirror corresponding to a swiping operation in the graphical user interface, in response to the swiping operation swiping from an edge of the graphical user interface into the graphical user interface.

Since the content displayed on the graphical user interface is mainly the picture in front of the field of view of the target virtual object, however, in a racing type game, the user not only needs to observe the field of view in front, but also needs to observe the field of view in the rear. For example, when the racing type game is a car racing game, the user who controls the target virtual object needs to observe the distance with the rear vehicle, to determine whether the rear vehicle overtakes him or her, so as to respond in time.

In this embodiment, when a swiping operation swiping from the edge of the graphical user interface into the graphical user interface is detected, the function of displaying the target rearview mirror image can be triggered. Specifically, when there is only one rearview mirror, the rearview mirror is the target rearview mirror. When there are more than one rearview mirror, the target rearview mirror corresponding to the swiping operation can be further determined according to the preset association relationship between the type of the swiping operation and the rearview mirror, and then the target rearview mirror image can be displayed in the graphical user interface.

After determining the target rearview mirror, the target rearview mirror image can be displayed in an area of the graphical user interface. The area for displaying the target rearview mirror image can be fixed, that is, it is irrelevant with the type of the target rearview mirror. The area for displaying the target rearview mirror image can also change correspondingly according to the type of the target rearview mirror, that is, different rearview mirrors are associated with different display areas. After the target rearview mirror is determined, the target rearview mirror image can be displayed in the display area associated with the target rearview mirror.

In the disclosed embodiment, by displaying a target rearview mirror image of a target rearview mirror corresponding to a swiping operation in the graphical user interface in response to the swiping operation swiping from an edge of the graphical user interface into the graphical user interface, it can facilitate users to view the rearview mirror image. Compared with the related art of viewing the rearview mirror image by clicking a button, the interactive method for displaying the rearview mirror image provided by the disclosed embodiment can reduce the use of interactive controls, has a higher fault tolerance rate, and is more convenient for user operation, thereby improving interactive experience of the user.

The information processing method in this example embodiment will be further described below.

In step 101, in response to the swiping operation swiping from an edge of the graphical user interface into the graphical user interface, a target rearview mirror image of a target rearview mirror corresponding to a swiping operation is displayed in the graphical user interface.

For the terminal device, the swiping trajectory of the swiping operation in the graphical user interface can be obtained. When the starting point of the swiping trajectory is at the edge of the graphical user interface, it can be determined that the swiping operation swipes from the edge of the graphical user interface into the graphical user interface, and then the target rearview mirror corresponding to the swiping operation can be determined. The swiping operations shown in FIG. 2 all swipes from the edge of the graphical user interface into the graphical user interface. That is, when the graphical user interface does not fill the touch display screen, the swiping starting point of the swiping operation can be at the edge of the graphical user interface, or between edges of the graphical user interface and the touch display screen, or at the edge of the touch display screen.

When the graphical user interface fills the touch display screen of the terminal device, the edge of the graphical user interface is the edge of the touch display screen. Therefore, when the graphical user interface fills the touch display screen of the terminal device, the swiping trajectory of the swiping operation in the touch display screen can be obtained, when the starting point of the swiping trajectory is at the edge of the touch display screen, it can be determined that the swiping operation swipes from the edge of the graphical user interface into the graphical user interface, and then the target rearview mirror corresponding to the swiping operation is determined.

In an optional embodiment of the present disclosure, the number of rearview mirror can be only one. Taking the target virtual object as a virtual vehicle or a driver in a virtual vehicle as an example, the virtual vehicle can have only one rearview mirror, for presenting the rear information of the virtual vehicle. For example, the rearview mirror can be an interior rearview mirror.

When the user needs to view the rear picture of the virtual vehicle during the process of controlling the target virtual object, a swiping operation swiping from the edge of the graphical user interface into the graphical user interface can be performed, to trigger the graphical user interface to display the target rearview mirror image of the target rearview mirror. Since there is only one rearview mirror in this embodiment, when a swiping operation swiping from the edge of the graphical user interface into the graphical user interface is detected, the rearview mirror can be directly determined as the target rearview mirror corresponding to the swiping operation, and the image presented by the target rearview mirror, i.e., the target rearview mirror image, is displayed in the graphical user interface.

In another optional embodiment of the present disclosure, the number of rearview mirrors is at least two. Also, taking the target virtual object as a virtual vehicle or a driver in a virtual vehicle as an example, the virtual vehicle can have left and right rearview mirrors, which are used to present the left and right rear information of the virtual vehicle, respectively. Optionally, in some game applications, the virtual vehicle can also have an interior rearview mirror, which is used to present the information directly behind the virtual vehicle.

When the user needs to view the rear picture of the virtual vehicle during the process of controlling the target virtual object, a swiping operation swiping from the edge of the graphical user interface into the graphical user interface can be performed, to trigger the graphical user interface to display the target rearview mirror image of the target rearview mirror. Since there are a plurality of rearview mirrors in this embodiment, when a swiping operation swiping from the edge of the graphical user interface into the graphical user interface is detected, it is necessary to determine the target rearview mirror from the plurality of rearview mirrors, to display the target rearview mirror image of the target rearview mirror in the graphical user interface.

When there are a plurality of rearview mirrors, the type of swiping operation corresponding to each rearview mirror can be preset, so that when a swiping operation swiping from the edge of the graphical user interface is detected, the type of swiping operation can be judged, and then combined with the preset type of swiping operation corresponding to each rearview mirror, the target rearview mirror to be displayed, i.e., the target rearview mirror corresponding to the swiping operation, can be determined.

After determining the target rearview mirror, the target rearview mirror image can be displayed in an area of the graphical user interface. The area for displaying the target rearview mirror image can be fixed, that is, it is irrelevant with the type of the target rearview mirror. The area for displaying the target rearview mirror image can also change correspondingly according to the type of the target rearview mirror, that is, different rearview mirrors are associated with different display areas. After the target rearview mirror is determined, the target rearview mirror image can be displayed in the display area associated with the target rearview mirror.

In an optional embodiment of the present disclosure, displaying a target rearview mirror image of a target rearview mirror corresponding to a swiping operation in the graphical user interface in response to the swiping operation swiping from an edge of the graphical user interface into the graphical user interface, may include: determining the target rearview mirror corresponding to the swiping operation according to a target edge when the swiping operation swipes into the graphical user interface, in response to the swiping operation swiping from the edge of the graphical user interface into the graphical user interface.

In this embodiment, by associating the rearview mirror with the edge into which the swiping operation is swiped, different rearview mirrors are associated with different edges, and the target rearview mirror for displaying the rearview mirror image is determined according to the target edge into which the actually detected swiping operation is swiped; the user can perform a swiping operation of swiping into the graphical user interface at any position of different edges to trigger the display of the corresponding rearview mirror image, which can improve the convenience and flexibility of operation.

In an example, the virtual vehicle may have a first rearview mirror and a second rearview mirror, the first rearview mirror is associated with the first edge, and the second rearview mirror is associated with the second edge.

For example, the first rearview mirror may be a left rearview mirror, and the second rearview mirror may be a right rearview mirror; the first edge may be a left edge, and the second edge may be a right edge.

When a swiping operation swiping from any position of the left edge of the graphical user interface into the graphical user interface is detected, it is determined that the left rearview mirror is the target rearview mirror. When a swiping operation swiping from any position of the right edge of the graphical user interface into the graphical user interface is detected, it is determined that the right left rearview mirror is the target rearview mirror. When a swiping operation swiping from the upper/lower edge of the graphical user interface into the graphical user interface is detected, since there is no rearview mirror associated with the upper/lower edge, there is no target rearview mirror corresponding to the swiping operation, and it can be considered that the swiping operation cannot trigger the display of the rearview mirror image.

In another example, the virtual vehicle may also have three rearview mirrors, each of which is associated with a different edge. For example, the first rearview mirror is associated with the first edge, the second rearview mirror is associated with the second edge, and the third rearview mirror is associated with the third edge.

For example, the first rearview mirror may be a left rearview mirror, the second rearview mirror may be a right rearview mirror, and the third rearview mirror may be an inner rearview mirror. The first edge may be a left edge, the second edge may be a right edge, and the third edge may be an upper and/or lower edge.

When a swiping operation swiping from any position of the left edge of the graphical user interface into the graphical user interface is detected, it is determined that the left rearview mirror is the target rearview mirror. When a swiping operation swiping from any position of the right edge of the graphical user interface into the graphical user interface is detected, it is determined that the right left rearview mirror is the target rearview mirror. When a swiping operation swiping from any position of the upper/lower edge of the graphical user interface into the graphical user interface is detected, it is determined that the inner rearview mirror is the target rearview mirror.

In another optional embodiment of the present disclosure, displaying a target rearview mirror image of a target rearview mirror corresponding to a swiping operation in the graphical user interface in response to the swiping operation swiping from an edge of the graphical user interface into the graphical user interface, includes:

determining the target rearview mirror corresponding to the swiping operation according to a target swiping direction of the swiping operation, in response to the swiping operation swiping from the edge of the graphical user interface into the graphical user interface.

In this embodiment, the number of rearview mirrors is two, by associating the rearview mirror with the swiping direction of the swiping operation, the target rearview mirror for displaying the rearview mirror image is determined according to the target swiping direction of the swiping operation actually detected. The swiping direction includes a first swiping direction and a second swiping direction, and whether the swiping direction of the swiping operation is the first swiping direction or the second swiping direction can be determined by the magnitude relationship between the longitudinal or lateral offset between the end point and the starting point of the swiping operation and 0. In this embodiment, the user can perform swiping operations in different directions on the same side edge or different side edges to trigger the display of different rearview mirror images, which can improve the convenience and flexibility of the operation. For example, when the first swiping direction is a longitudinal offset between the end point and the starting point of the swiping operation greater than 0, and the second swiping direction is a longitudinal offset between the end point and the starting point of the swiping operation smaller than 0, the user can perform swiping operations in different directions on the same side edge. For example, the user can perform an upward swiping operation on the left edge, that is, perform a swiping operation in the first swiping direction, and can also perform a downward swiping operation on the left edge, that is, perform a swiping operation in the second swiping direction. The user can perform swiping operations in different directions on different side edges. For example, the user can perform an upward swiping operation on the lower edge, that is, perform a swiping operation in the first swiping direction, and perform a downward swiping operation on the upper edge, that is, perform a swiping operation in the second swiping direction; or, the user can perform an upward swiping operation on the left edge, that is, perform a swiping operation in the first swiping direction, and perform a downward swiping operation on the right edge, that is, perform a swiping operation in the second direction.

For example, the process of determining the target swiping direction of the swiping operation may include:
determining the longitudinal offset between the end point and the starting point of the swiping trajectory according to the swiping trajectory of the swiping operation in the graphical user interface;
when the longitudinal offset is greater than 0, determining the target swiping direction of the swiping operation as the first swiping direction;
when the longitudinal offset is smaller than 0, determining the target swiping direction of the swiping operation as the second swiping direction.

As shown in FIG. 3, a plane rectangular coordinate system parallel to the graphical user interface may be established. According to the swiping trajectory of the swiping operation in the graphical user interface, the starting point coordinate (0, y0) and the end point coordinate (x1, y1) of the swiping trajectory may be obtained, and the longitudinal offset Δy=y1−y0 between the end point coordinate and the starting point coordinate is calculated. When the longitudinal offset is greater than 0, it is determined that the target swiping direction is the first swiping direction, and when the longitudinal offset is smaller than 0, it is determined that the target swiping direction is the second swiping direction.

In one example, the virtual vehicle may have a first rearview mirror and a second rearview mirror, the first rearview mirror is associated with the first swiping direction, and the second rearview mirror is associated with the second swiping direction.

For example, the first rearview mirror may be a left rearview mirror, and the second rearview mirror may be a right rearview mirror. The first swiping direction may be a longitudinal offset greater than 0, and the second swiping direction may be a longitudinal offset smaller than O.

When a swiping operation swiping from one side edge (such as the left edge) of the graphical user interface upward into the graphical user interface is detected, that is, the longitudinal offset is greater than 0, the target swiping direction is the first swiping direction, according to the association relationship between the first rearview mirror and the first swiping direction, it can be determined that the first rearview mirror is the target rearview mirror. In this example, the first rearview mirror is the left rearview mirror, so it is determined that the left rearview mirror is the target rearview mirror. When a swiping operation swiping from one side edge (such as the left edge) of the graphical user interface downward into the graphical user interface is detected, that is, the longitudinal offset is smaller than 0, the target swiping direction is the second swiping direction, according to the association relationship between the second rearview mirror and the second swiping direction, it can be determined that the second rearview mirror is the target rearview mirror. In this example, the second rearview mirror is the right rearview mirror, so it is determined that the right rearview mirror is the target rearview mirror.

In other embodiments, the target swiping direction can also be determined by the lateral offset between the end point and the starting point of the swiping trajectory. For example, when the lateral offset is greater than 0, it is determined that the target swiping direction is the first swiping direction, and when the lateral offset is smaller than 0, it is determined that the target swiping direction is the second swiping direction. The specific implementation process is similar to the above-mentioned determination of the target swiping direction by the longitudinal offset, and will not be repeated.

In another optional embodiment of the present disclosure, displaying a target rearview mirror image of a target rearview mirror corresponding to a swiping operation in the graphical user interface in response to the swiping operation swiping from an edge of the graphical user interface into the graphical user interface, includes:
in response to the swiping operation swiping from the edge of the graphical user interface into the graphical user interface,
determining the target rearview mirror corresponding to the swiping operation according to a target edge, when a target swiping direction of the swiping operation matches a preset swiping direction corresponding to the target edge when the swiping operation swipes into the graphical user interface.

In this embodiment, the rearview mirror is associated with the edge into which the swiping operation is swiped, and the edge is associated with the swiping direction at the same time. Only when the swiping operation in the swiping direction associated with the edge is swiped from the edge, the function of displaying the rearview mirror image can be triggered, which can effectively prevent misoperation. The process of determining the swiping direction can refer to the above description and will not be repeated here.

In one example, the virtual vehicle may have a first rearview mirror and a second rearview mirror, the first rearview mirror is associated with the first edge, the second rearview mirror is associated with the second edge; the first edge is associated with the first swiping direction, and the second edge is associated with the second swiping direction.

For example, the first rearview mirror may be a left rearview mirror, and the second rearview mirror may be a right rearview mirror; the first edge may be the left edge of the graphical user interface, and the second edge may be the right edge of the graphical user interface; the first swiping direction may be a direction in which the longitudinal offset between the end point and the starting point of the swiping trajectory is greater than 0, and the second swiping direction may be a direction in which the longitudinal offset between the end point and the starting point of the swiping trajectory is smaller than 0.

When a swiping operation of swiping from the first edge (left edge) of the graphical user interface upward into the graphical user interface is detected (i.e., the longitudinal offset is greater than 0), the target swiping direction is the first swiping direction, according to the association between the first edge and the first swiping direction, it is determined that the target swiping direction matches the preset swiping direction corresponding to the first edge, and then according to the association between the first rearview mirror and the first edge, it is determined that the first rearview mirror is the target rearview mirror. In this example, the first rearview mirror is the left rearview mirror, therefore, it is determined that the left rearview mirror is the target rearview mirror. When a swiping operation of swiping from the second edge (right edge) of the graphical user interface downward into the graphical user interface is detected (i.e., the longitudinal offset is smaller than 0), the target swiping direction is the second swiping direction, according to the association between the second edge and the second swiping direction, it is determined that the target swiping direction matches the preset swiping direction corresponding to the second edge, and then according to the association between the second rearview mirror and the second edge, it is determined that the second rearview mirror is the target rearview mirror. In this example, the second rearview mirror is the right rearview mirror, therefore, it is determined that the right rearview mirror is the target rearview mirror. When a swiping operation swiping from the first edge (left edge) of the graphical user interface downward into the graphical user interface is detected, that is, the longitudinal offset is smaller than 0, the target swiping direction is the second swiping direction, according to the association between the first edge and the first swiping direction, it is determined that the target swiping direction does not match the preset swiping direction corresponding to the first edge, and it is considered that this swiping operation cannot trigger the display of the rearview mirror image. When a swiping operation swiping from the upper/lower edge of the graphical user interface into the graphical user interface is detected, since there is no rearview mirror associated with the upper/lower edge, there is no target rearview mirror corresponding to this swiping operation, and it can be considered that this swiping operation cannot trigger the display of the rearview mirror image.

After determining the target rearview mirror, the target rearview mirror image can be displayed in an area of the graphical user interface. The area for displaying the target rearview mirror image can be fixed, that is, it is irrelevant with the type of the target rearview mirror. The area for displaying the target rearview mirror image can also change correspondingly according to the type of the target rearview mirror, that is, different rearview mirrors are associated with different display areas. After the target rearview mirror is determined, the target rearview mirror image can be displayed in the display area associated with the target rearview mirror.

In one example, when there are two rearview mirrors, namely the first rearview mirror and the second rearview mirror, the first rearview mirror can be associated with the first display area, and the second rearview mirror can be associated with the second display area.

For example, the first rearview mirror can be the left rearview mirror, and the second rearview mirror can be the right rearview mirror; the first display area can be the left display area at the left side of the center line of the graphical user interface, and the second display area can be the right display area at the right side of the center line of the graphical user interface.

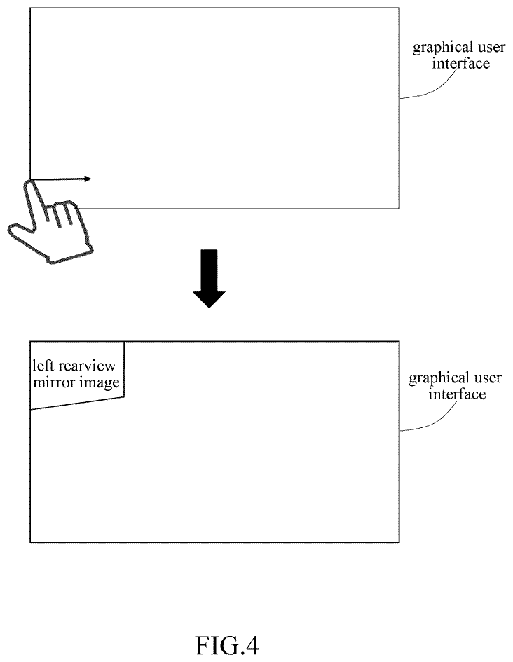

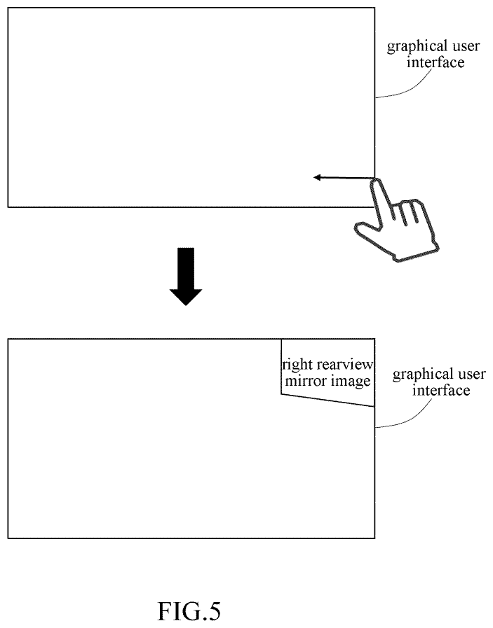

As shown in FIG. 4, when the target rearview mirror is the left rearview mirror, the left rearview mirror image is displayed in the left display area, and the left display area is located in the upper left corner of the graphical user interface. As shown in FIG. 5, when the target rearview mirror is the right rearview mirror, the right rearview mirror image is displayed in the right display area, and the right display area is located in the upper right corner of the graphical user interface.

In another example, when there are three rearview mirrors, namely the first rearview mirror, the second rearview mirror, and the third rearview mirror respectively, different display areas can be associated with each rearview mirror.

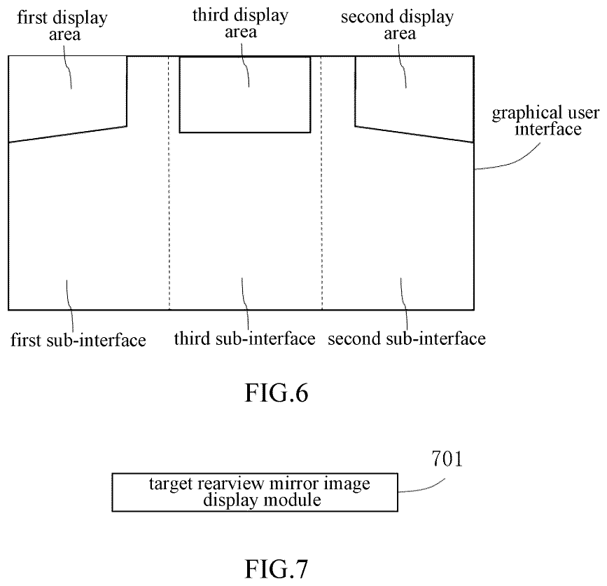

For example, the first rearview mirror may be a left rearview mirror, the second rearview mirror may be a right rearview mirror, and the third rearview mirror may be an inner rearview mirror. As shown in FIG. 6, the graphical user interface is divided into a first sub-interface, a second sub-interface, and a third sub-interface. The first display area may be in the first sub-interface, the second display area may be in the second sub-interface, and the third display area may be in the third sub-interface.

When the target rearview mirror is a left rearview mirror, the left rearview mirror image is displayed in the first display area. When the target rearview mirror is a right rearview mirror cover, the right rearview mirror image is displayed in the second display area. When the target rearview mirror is an inner rearview mirror, the inner rearview mirror image is displayed in the third display area.

By associating different rearview mirrors with different display areas, it is convenient for users to accurately judge the rear situation. In particular, the corresponding display area is set in combination with the positional relationship of the rearview mirror, and the corresponding swiping operation type is combined to better meet usage habits of the user. For example, referring to FIG. 4 and FIG. 5, in response to a swiping operation swiping from the left edge of the graphical user interface into the graphical user interface, the left rearview mirror image is displayed in the left display area of the graphical user interface; in response to a swiping operation swiping from the right edge of the graphical user interface into the graphical user interface, the right rearview mirror image is displayed in the right display area of the graphical user interface.

Further, in an optional embodiment of the present disclosure, the method further includes:
ending display of the target rearview mirror image, in response to that a continuous display duration of the target rearview mirror image in the graphical user interface reaches a preset duration.

In this embodiment, the preset duration for continuous display of the target rearview mirror image in the graphical user interface can be set. When the continuous display duration of the target rearview mirror reaches the preset duration, the display is automatically ended. On the basis of satisfying the requirement of the user to view the target rearview mirror image, it can also automatically avoid the target rearview mirror image blocking the front view for a long time period, causing interference to the user.

The preset duration can be set by the user to meet the usage habits of different users. When the user does not set the preset duration, the default preset time can be used. For example, the default preset time can be 2 seconds.

Optionally, the time to end the display of the target rearview mirror image can also be automatically adjusted according to whether there are other virtual objects in the target rearview mirror image. For example, when there are no other virtual objects in the time period when the continuous display duration of the target rearview mirror image reaches the judgment duration, the display of the target rearview mirror image is ended, wherein the judgment duration is smaller than the preset duration. When there are other virtual objects in the time period when the continuous display duration of the target rearview mirror image reaches the judgment duration, the display of the target rearview mirror image is ended when the continuous display duration reaches the preset duration. For example, the preset duration is 2 seconds, the judgment duration is 1 second, within 1 second of display of the left rearview mirror image, if there are no other virtual objects in the left rearview mirror image, the display can be ended when the left rearview mirror image is displayed for 1 second; if there are other virtual objects, the display can be ended when the left rearview mirror image is displayed for 2 seconds.

Further, in an optional embodiment of the present disclosure, the above method may also include:
when the target rearview mirror is a first rearview mirror and in a process of displaying a first rearview mirror image of the first rearview mirror, in response to the swiping operation corresponding to a second rearview mirror, displaying a second rearview mirror image of the second rearview mirror in the graphical user interface, and ending display of the first rearview mirror image simultaneously.

In this embodiment, in the process of displaying a rearview mirror image, when a swiping operation that triggers the display of another rearview mirror image is detected, the another rearview mirror image is displayed in the graphical user interface, to meet the needs of the user at the first time. When the area used to display the target rearview mirror image is irrelevant with the type of the target rearview mirror, the display of the currently displayed rearview mirror image is automatically ended while displaying the another rearview mirror image. When different rearview mirrors are associated with different display areas, by ending the display of the currently displayed rearview mirror image while displaying the another rearview mirror image, it can avoid a plurality of rearview mirror images from being displayed in the interface at the same time, occupying too much of the front field of view, causing interference to the user.

For example, when a swiping operation that triggers the display of the right rearview mirror image is detected during the display of the left rearview mirror image, the right rearview mirror image is displayed in the display area corresponding to the right rearview mirror. Even if the left rearview mirror image does not reach the preset duration, the display will be ended due to the swiping operation that triggers the display of the right rearview mirror image.

In other optional embodiments, when there are a plurality of rearview mirrors and different rearview mirrors are associated with different display areas, the above method may also include:
when the target rearview mirror is a first rearview mirror and in a process of displaying a first rearview mirror image of the first rearview mirror, in response to the swiping operation corresponding to a second rearview mirror, simultaneously displaying a second rearview mirror image of the second rearview mirror in the graphical user interface.

In this embodiment, when a swiping operation that triggers the display of another rearview mirror image is detected during the display of one rearview mirror image, the another rearview mirror image is simultaneously displayed in the graphical user interface, to meet the requirement of the user to view different rearview mirror images at the same time. For example, during the process of displaying the left rearview mirror image, when a swiping operation that triggers the display of the right rearview mirror image is detected, the right rearview mirror image is displayed in the display area corresponding to the right rearview mirror, and the display of the left rearview mirror image is not affected.

Further, in an optional embodiment of the present disclosure, the above method may also include:
during the process of displaying the target rearview mirror image, in response to detecting a swiping operation corresponding to the target rearview mirror, the continuous display duration of the target rearview mirror is re-determined.

In this embodiment, during the process of displaying a rearview mirror image, when a swiping operation that triggers the currently displayed rearview mirror image is detected, the timer that records the continuous display duration of the target rearview mirror is reset, to re-determine the continuous display duration of the target rearview mirror.

For example, during the process of displaying the left rearview mirror image, when a swiping operation that triggers the display of the left rearview mirror image is detected, the timer is reset, that is, the timer is re-timed from the latest detection of the swiping operation that triggers the display of the rearview mirror image.

In other embodiments, when a swiping operation corresponding to the currently displayed target rearview mirror image is detected during the process of displaying the target rearview mirror image, the swiping operation may also be ignored.

In the disclosed embodiment, in response to the swiping operation swiping from the edge of the graphical user interface into the graphical user interface, the target rearview mirror image of the target rearview mirror corresponding to the swiping operation is displayed in the target display area, in response to that the continuous display duration of the target rearview mirror image in the graphical user interface reaches the preset duration, the display of the target rearview mirror image is automatically ended, which can facilitate the user to view the rearview mirror image, and automatically end the display, automatically avoid the target rearview mirror image from blocking the front field of view for a long time, and causes interference to the user. Compared with the related art of viewing the rearview mirror image by clicking a button, the information processing method for displaying the rearview mirror image provided by the disclosed embodiment can reduce the use of interactive controls, has a higher fault tolerance rate, and is more convenient for user operation, thereby improving interactive experience of the user.

It should be noted that for the method embodiment, for the sake of simple description, it is expressed as a series of action combinations, but those skilled in the art should know that the disclosed embodiment is not limited by the described action sequence, because according to the disclosed embodiment, some steps can be performed in other sequences or simultaneously. Secondly, those skilled in the art should also know that the embodiments described in the specification are all preferred embodiments, and the actions involved are not necessarily required by the embodiments of the present disclosure.

Referring to FIG. 7, a structural block diagram of an information processing apparatus embodiment of the present disclosure is shown. Corresponding to the above-mentioned information processing method embodiment, an application is executed on a processor of a terminal device and a graphical user interface is rendered on a touch display screen of the terminal device, the graphical user interface at least presents a picture in front of field of view of a target virtual object. The information processing apparatus provided by the embodiment of the present disclosure may include the following module:
a target rearview mirror image display module 701, configured to display a target rearview mirror image of a target rearview mirror corresponding to a swiping operation in the graphical user interface, in response to the swiping operation swiping from an edge of the graphical user interface into the graphical user interface.

Optionally, the target rearview mirror image display module 701 includes:
a target rearview mirror first determination module, configured to determine the target rearview mirror corresponding to the swiping operation according to a target edge when the swiping operation swipes into the graphical user interface, in response to the swiping operation swiping from the edge of the graphical user interface into the graphical user interface.

Optionally, the target rearview mirror image display module 701 includes:
a target rearview mirror second determination module, configured to determine the target rearview mirror corresponding to the swiping operation according to a target swiping direction of the swiping operation, in response to the swiping operation swiping from the edge of the graphical user interface into the graphical user interface.

Optionally, the target rearview mirror image display module 701 includes:
a target rearview mirror third determination module, configured to: in response to the swiping operation swiping from the edge of the graphical user interface into the graphical user interface, when a target swiping direction of the swiping operation matches a preset swiping direction corresponding to the target edge when the swiping operation swipes into the graphical user interface, determine the target rearview mirror corresponding to the swiping operation according to a target edge.

Optionally, the target rearview mirror image display module 701 is configured to determine a target display area corresponding to the target rearview mirror, and display the target rearview mirror image in the target display area.

Optionally, the apparatus further includes:
an ending display module, configured to end display of the target rearview mirror image, in response to that a continuous display duration of the target rearview mirror image in the graphical user interface reaches a preset duration.

Optionally, the apparatus further includes:
a second display module, configured to, when the target rearview mirror is a first rearview mirror and in a process of displaying a first rearview mirror image of the first rearview mirror, in response to the swiping operation corresponding to a second rearview mirror, display a second rearview mirror image of the second rearview mirror in the graphical user interface, and end display of the first rearview mirror image simultaneously.

For the apparatus embodiment, since it is basically similar to the method embodiment, the description is relatively simple, and the relevant parts can be referred to the description of the method embodiment.

The embodiment of the present disclosure also discloses an electronic device, including a processor, a memory, and a computer program stored in the memory and capable of running on the processor, wherein the computer program implements steps of the information processing method described above when executed by the processor. Specifically, the following step can be implemented:
displaying a target rearview mirror image of a target rearview mirror corresponding to a swiping operation in the graphical user interface, in response to the swiping operation swiping from an edge of the graphical user interface into the graphical user interface.

Optionally, displaying a target rearview mirror image of a target rearview mirror corresponding to a swiping operation in the graphical user interface in response to the swiping operation swiping from an edge of the graphical user interface into the graphical user interface, includes: determining the target rearview mirror corresponding to the swiping operation according to a target edge when the swiping operation swipes into the graphical user interface, in response to the swiping operation swiping from the edge of the graphical user interface into the graphical user interface.

Optionally, displaying a target rearview mirror image of a target rearview mirror corresponding to a swiping operation in the graphical user interface in response to the swiping operation swiping from an edge of the graphical user interface into the graphical user interface, includes: determining the target rearview mirror corresponding to the swiping operation according to a target swiping direction of the swiping operation, in response to the swiping operation swiping from the edge of the graphical user interface into the graphical user interface.

Optionally, displaying a target rearview mirror image of a target rearview mirror corresponding to a swiping operation in the graphical user interface in response to the swiping operation swiping from an edge of the graphical user interface into the graphical user interface, includes: in response to the swiping operation swiping from the edge of the graphical user interface into the graphical user interface, determining the target rearview mirror corresponding to the swiping operation according to a target edge, when a target swiping direction of the swiping operation matches a preset swiping direction corresponding to the target edge when the swiping operation swipes into the graphical user interface.

Optionally, displaying a target rearview mirror image of a target rearview mirror corresponding to a swiping operation in the graphical user interface includes: determining a target display area corresponding to the target rearview mirror, and displaying the target rearview mirror image in the target display area.

Optionally, the following step may also be implemented: ending display of the target rearview mirror image, in response to that a continuous display duration of the target rearview mirror image in the graphical user interface reaches a preset duration.

Optionally, the following step may also be implemented: when the target rearview mirror is a first rearview mirror and in a process of displaying a first rearview mirror image of the first rearview mirror, in response to the swiping operation corresponding to a second rearview mirror, displaying a second rearview mirror image of the second rearview mirror in the graphical user interface, and ending display of the first rearview mirror image simultaneously.

In the above steps, in response to the swiping operation swiping from the edge of the graphical user interface into the graphical user interface, the target rearview mirror image of the target rearview mirror corresponding to the swiping operation is displayed in the graphical user interface, which can facilitate the user to view the rearview mirror image. Compared with the related art of viewing the rearview mirror image by clicking a button, it can reduce the use of interactive controls, has a higher fault tolerance rate, and is more convenient for user operation, thereby improving interactive experience of the user.

The embodiment of the present disclosure also discloses a computer-readable storage medium, having a computer program stored thereon, wherein the computer program implements steps of the information processing method described above when executed by a processor. Specifically, the following step can be implemented:

displaying a target rearview mirror image of a target rearview mirror corresponding to a swiping operation in the graphical user interface, in response to the swiping operation swiping from an edge of the graphical user interface into the graphical user interface.

Optionally, displaying a target rearview mirror image of a target rearview mirror corresponding to a swiping operation in the graphical user interface in response to the swiping operation swiping from an edge of the graphical user interface into the graphical user interface, includes: determining the target rearview mirror corresponding to the swiping operation according to a target edge when the swiping operation swipes into the graphical user interface, in response to the swiping operation swiping from the edge of the graphical user interface into the graphical user interface.

Optionally, displaying a target rearview mirror image of a target rearview mirror corresponding to a swiping operation in the graphical user interface in response to the swiping operation swiping from an edge of the graphical user interface into the graphical user interface, includes: determining the target rearview mirror corresponding to the swiping operation according to a target swiping direction of the swiping operation, in response to the swiping operation swiping from the edge of the graphical user interface into the graphical user interface.

Optionally, displaying a target rearview mirror image of a target rearview mirror corresponding to a swiping operation in the graphical user interface in response to the swiping operation swiping from an edge of the graphical user interface into the graphical user interface, includes: in response to the swiping operation swiping from the edge of the graphical user interface into the graphical user interface, determining the target rearview mirror corresponding to the swiping operation according to a target edge, when a target swiping direction of the swiping operation matches a preset swiping direction corresponding to the target edge when the swiping operation swipes into the graphical user interface.

Optionally, displaying a target rearview mirror image of a target rearview mirror corresponding to a swiping operation in the graphical user interface includes: determining a target display area corresponding to the target rearview mirror, and displaying the target rearview mirror image in the target display area.

Optionally, the following step may also be implemented: ending display of the target rearview mirror image, in response to that a continuous display duration of the target rearview mirror image in the graphical user interface reaches a preset duration.

Optionally, the following step may also be implemented: when the target rearview mirror is a first rearview mirror and in a process of displaying a first rearview mirror image of the first rearview mirror, in response to the swiping operation corresponding to a second rearview mirror, displaying a second rearview mirror image of the second rearview mirror in the graphical user interface, and ending display of the first rearview mirror image simultaneously.

In the above steps, in response to the swiping operation swiping from the edge of the graphical user interface into the graphical user interface, the target rearview mirror image of the target rearview mirror corresponding to the swiping operation is displayed in the graphical user interface, which can facilitate the user to view the rearview mirror image. Compared with the related art of viewing the rearview mirror image by clicking a button, it can reduce the use of interactive controls, has a higher fault tolerance rate, and is more convenient for user operation, thereby improving interactive experience of the user.

Each embodiment in this specification is described in a progressive manner, and each embodiment focuses on the differences from other embodiments, and the same and similar parts between the embodiments can be referred to each other.

Those skilled in the art should understand that the embodiments of the present disclosure can be provided as methods, apparatuses, or computer program products. Therefore, the embodiments of the present disclosure can be in the form of a complete hardware embodiment, a complete software embodiment, or an embodiment combining software and hardware. Moreover, the embodiments of the present disclosure may be in the form of a computer program product implemented on one or more computer-usable storage media (including but not limited to disk storage, CD-ROM, optical storage, etc.) containing computer-usable program codes.

The embodiments of the present disclosure are described with reference to flowcharts and/or block diagrams of methods, terminal devices (systems), and computer program products according to the embodiments of the present disclosure. It should be understood that each process and/or block in the flowchart and/or block diagram, as well as the combination of processes and/or blocks in the flowchart and/or block diagram, can be implemented by computer program instructions. These computer program instructions can be provided to a processor of a general-purpose computer, a special-purpose computer, an embedded processor, or other programmable data processing terminal device to generate a machine, so that the instructions executed by the processor of the computer or other programmable data processing terminal devices generate an apparatus for implementing the functions specified in one or more processes in the flowchart and/or one or more blocks in the block diagram.

These computer program instructions may also be stored in a computer-readable memory that can guide a computer or other programmable data processing terminal devices to work in a specific manner, so that the instructions stored in the computer-readable memory produce a product including an instruction device, which implements the functions specified in one or more processes of the flowchart and/or one or more blocks of the block diagram.

These computer program instructions may also be loaded onto a computer or other programmable data processing terminal devices, so that a series of operation steps are performed on the computer or other programmable terminal devices to produce a computer-implemented process, so that the instructions executed on the computer or other programmable terminal devices provide steps for implementing the functions specified in one or more processes of the flowchart and/or one or more blocks of the block diagram.

Although the preferred embodiments of the embodiments of the present disclosure have been described, those skilled in the art may make additional changes and modifications to these embodiments once they know the basic creative concepts. Therefore, the appended claims are intended to be interpreted as including the preferred embodiments and all changes and modifications that fall within the scope of the embodiments of the present disclosure.

Finally, it should also be noted that in this article, relational terms such as first and second, etc. are only used to distinguish one entity or operation from another entity or operation, and do not necessarily require or imply any such actual relationship or order between these entities or operations. Moreover, the terms “including”, “including” or any other variants thereof are intended to cover non-exclusive inclusion, so that a process, method, article or terminal device including a series of elements includes not only those elements, but also includes other elements not explicitly listed, or also includes elements inherent to such process, method, article or terminal device. In the absence of further restrictions, the elements defined by the sentence “including a . . . ” do not exclude the existence of other identical elements in the process, method, article or terminal device including the elements.

The above is a detailed introduction to an information processing method and apparatus, electronic device and storage medium provided by the present disclosure. The principle and implementation of the present disclosure are described in this article using specific examples. The description of the above embodiments is only used to help understand the method and its core idea of the present disclosure. At the same time, for those skilled in the art, according to the idea of the present disclosure, there will be changes in the specific implementation and application scope. In summary, the content of this specification should not be understood as a limitation on the present disclosure.

1. An information processing method, the method comprising:
executing an application on a processor of a terminal device and rendering a graphical user interface on a touch display screen of the terminal device, wherein the graphical user interface at least presents a picture in front of field of view of a target virtual object; and
displaying a target rearview mirror image of a target rearview mirror corresponding to a swiping operation in the graphical user interface, in response to the swiping operation swiping from an edge of the graphical user interface into the graphical user interface.

2. The method according to claim 1, wherein displaying the target rearview mirror image in the graphical user interface in response to the swiping operation comprises:
determining the target rearview mirror corresponding to the swiping operation according to a target edge when the swiping operation swipes into the graphical user interface, in response to the swiping operation swiping from the edge of the graphical user interface into the graphical user interface.

3. The method according to claim 1, wherein displaying the target rearview mirror image in the graphical user interface in response to the swiping operation comprises:
determining the target rearview mirror corresponding to the swiping operation according to a target swiping direction of the swiping operation, in response to the swiping operation swiping from the edge of the graphical user interface into the graphical user interface.

4. The method according to claim 1, wherein displaying the target rearview mirror image in the graphical user interface in response to the swiping operation comprises:
in response to the swiping operation swiping from the edge of the graphical user interface into the graphical user interface,
determining the target rearview mirror corresponding to the swiping operation according to a target edge in response to determining that a target swiping direction of the swiping operation matches a preset swiping direction corresponding to the target edge when the swiping operation swipes into the graphical user interface.

5. The method according to claim 1, wherein displaying the target rearview mirror image in the graphical user interface comprises:
determining a target display area corresponding to the target rearview mirror, and displaying the target rearview mirror image in the target display area.

6. The method according to claim 1, further comprising:
ending display of the target rearview mirror image, in response to that a continuous display duration of the target rearview mirror image in the graphical user interface reaches a preset duration.

7. The method according to claim 5, further comprising:
in a case that the target rearview mirror is a first rearview mirror and in a process of displaying a first rearview mirror image of the first rearview mirror, in response to the swiping operation corresponding to a second rearview mirror, displaying a second rearview mirror image of the second rearview mirror in the graphical user interface, and ending display of the first rearview mirror image simultaneously.

8. (canceled)

9. An electronic device, comprising a processor, a memory, and a computer program stored in the memory and capable of running on the processor, wherein the computer program implements an information processing method when executed by the processor, the method comprising:
executing an application on a processor of a terminal device and rendering a graphical user interface on a touch display screen of the terminal device, wherein the graphical user interface at least presents a picture in front of field of view of a target virtual object; and
displaying a target rearview mirror image of a target rearview mirror corresponding to a swiping operation in the graphical user interface, in response to the swiping operation swiping from an edge of the graphical user interface into the graphical user interface.

10. A non-transitory computer-readable storage medium, having a computer program stored thereon, wherein the computer program implements an information processing method when executed by a processor, the method comprising:
executing an application on a processor of a terminal device and rendering a graphical user interface on a touch display screen of the terminal device, wherein the graphical user interface at least presents a picture in front of field of view of a target virtual object; and
displaying a target rearview mirror image of a target rearview mirror corresponding to a swiping operation in the graphical user interface, in response to the swiping operation swiping from an edge of the graphical user interface into the graphical user interface.

11. The method according to claim 3, wherein the target swiping direction of the swiping operation is determined as follows:
determining a longitudinal offset between an end point and a starting point of a swiping trajectory according to the swiping trajectory of the swiping operation in the graphical user interface;
determining the target swiping direction of the swiping operation as a first swiping direction in a case that the longitudinal offset is greater than 0, and;
determining the target swiping direction of the swiping operation as a second swiping direction in a case that the longitudinal offset is smaller than 0.

12. The method according to claim 3, wherein the target swiping direction of the swiping operation is determined as follows:
determining a lateral offset between an end point and a starting point of a swiping trajectory according to the swiping trajectory of the swiping operation in the graphical user interface;
determining the target swiping direction of the swiping operation as a first swiping direction in a case that the lateral offset is greater than 0, and;
determining the target swiping direction of the swiping operation as a second swiping direction in a case that the lateral offset is smaller than 0.

13. The method according to claim 6, further comprising:
during a process of displaying the target rearview mirror image, re-determining the continuous display duration of the target rearview mirror in response to detecting a swiping operation corresponding to the target rearview mirror.

14. The electronic device according to claim 9, wherein the processor is further configured to:
determine the target rearview mirror corresponding to the swiping operation according to a target edge when the swiping operation swipes into the graphical user interface, in response to the swiping operation swiping from the edge of the graphical user interface into the graphical user interface.

15. The electronic device according to claim 9, wherein the processor is further configured to:
determine the target rearview mirror corresponding to the swiping operation according to a target swiping direction of the swiping operation, in response to the swiping operation swiping from the edge of the graphical user interface into the graphical user interface.

16. The electronic device according to claim 9, wherein the processor is further configured to:
in response to the swiping operation swiping from the edge of the graphical user interface into the graphical user interface, determine the target rearview mirror corresponding to the swiping operation according to a target edge in response to determining that a target swiping direction of the swiping operation matches a preset swiping direction corresponding to the target edge when the swiping operation swipes into the graphical user interface.

17. The electronic device according to claim 9, wherein the processor is further configured to:
determine a target display area corresponding to the target rearview mirror, and display the target rearview mirror image in the target display area.

18. The electronic device according to claim 9, wherein the processor is further configured to:
end display of the target rearview mirror image, in response to that a continuous display duration of the target rearview mirror image in the graphical user interface reaches a preset duration.

19. The electronic device according to claim 17, wherein the processor is further configured to:
in a case that the target rearview mirror is a first rearview mirror and in a process of display a first rearview mirror image of the first rearview mirror, in response to the swiping operation corresponding to a second rearview mirror, display a second rearview mirror image of the second rearview mirror in the graphical user interface, and end display of the first rearview mirror image simultaneously.

20. The non-transitory computer-readable storage medium according to claim 10, wherein displaying the target rearview mirror image in the graphical user interface in response to the swiping operation comprises:
determining the target rearview mirror corresponding to the swiping operation according to a target edge when the swiping operation swipes into the graphical user interface, in response to the swiping operation swiping from the edge of the graphical user interface into the graphical user interface.

21. The non-transitory computer-readable storage medium according to claim 10, wherein displaying the target rearview mirror image in the graphical user interface in response to the swiping operation comprises:
determining the target rearview mirror corresponding to the swiping operation according to a target swiping direction of the swiping operation, in response to the swiping operation swiping from the edge of the graphical user interface into the graphical user interface.
